(19) United States
(12) Patent Application Publication
(10) Pub. No.: US 2008/0288527 A1
(43) Pub. Date: Nov. 20, 2008

(54) User interface for graphically representing groups of data

(75) Inventors: Glen Anthony Ames, Mountain View, CA (US); David A. Burgess, Menlo Park, CA (US); Lisa Akerman Ford, San Jose, CA (US); Sundara Raman Rajagopalan, Sunnyvale, CA (US); Amit Umesh Shanbhag, San Francisco, CA (US)

Correspondence Address: BEYER LAW GROUP LLP/YAHOO, PO BOX 1687, CUPERTINO, CA, 95015-1687, US

(73) Assignee: Yahoo! Inc., Sunnyvale, CA (US)

(21) Appl. No.: 11/804,233

(22) Filed: May 16, 2007

(51) Int. Cl. G06F 17/00

(52) U.S. Cl. 707/102; 707/E17.005

(57) ABSTRACT

A technique of operating a user interface that enables the user to graphically manipulate records of a dimensionally-modeled fact collection, which comprises the following: receiving a graphical selection of a subset from a set of data points, each data point representing at least one record of the dimensionally-modeled fact collection; receiving a graphical manipulation of the selected subset of data points; defining at least one data group using the selected subset of data points and based on the graphical manipulation, wherein each data group comprises between 0 to n records represented by the selected subset of data points, wherein n is the total number of data points in the set of data points; and graphically representing the at least one data group. Alternatively, the technique comprises the following: performing an operation on at least one data group as described above; and graphically representing a result of the operation.

### BACKGROUND OF THE INVENTION

1. Field of the Invention

The present invention relates to a user interface that enables users to graphically manipulate and analyze large datasets, where each dataset represents a dimensionally-modeled fact collection. More specifically, the present invention relates to a user interface that enables users to graphically group one or more multi-dimensional records from a large dataset into separate data groups, perform operations between two or more data groups, and graphically represent the results of the operations.

2. Background of the Invention

When interacting with and/or analyzing large datasets, where each dataset may contain a million or more multi-dimensional records, for example, it can be difficult, impractical, and even impossible for users to consider each multi-dimensional record and/or each single data value within the records individually. Instead, users often prefer to organize portions of the records into groups, perhaps based on some type of criteria. For example, a user may wish to group one portion of related records into one data group based on one type of criteria and another portion of related records into another data group based on a different type of criteria. Thereafter, the user may work with these data groups.

In order to organize portions of multi-dimensional records into data groups, users need a way to identify and/or select those records to be grouped together. One way is for users to manually go through the entire dataset, picking out each record of interest individually. However, this method may be very time consuming and impractical, especially when working with large datasets. It can be impractical and even impossible to display a million or more multi-dimensional records textually, such as in a spread sheet. And even if such large number of records could be displayed textually, it would be almost impossible for users to locate those records of particular interests in any reasonable amount of time. In addition, understanding the inter-relationships of these groups may be very difficult when the groups are displayed textually.

Accordingly, what is needed are systems and methods to address the above-identified problems.

### SUMMARY OF THE INVENTION

Broadly speaking, the present invention relates to a user interface that enables users to graphically manipulate and analyze large datasets, where each dataset represents a dimensionally-modeled fact collection.

In one embodiment, a computer-implemented method of operating a user interface is provided, which comprises the following: receiving a graphical selection of a subset from a set of data points, each data point representing at least one record of a dimensionally-modeled fact collection; receiving a graphical manipulation of the selected subset of data points; defining at least one data group using the selected subset of data points and based on the graphical manipulation, wherein each data group comprises between 0 to n records represented by the selected subset of data points, wherein n is the total number of data points in the set of data points; and graphically representing the at least one data group.

In another embodiment, a computer-implemented method of operating a user interface is provided, which comprises the following: performing an operation on at least one data group, wherein each data group comprises between 0 to n records, each record represented by a data point, wherein n is the total number of records in a dimensionally-modeled fact collection, wherein each data point represents at least one record; and graphically representing a result of the operation.

These and other features, aspects, and advantages of the invention will be described in more detail below in the detailed description and in conjunction with the following figures.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 is a flowchart of a method for a user to graphically interact with a display graphically representing a large dataset.

FIGS. 2A-2D are flowcharts of methods for a user to cause data groups to be defined.

FIGS. 3A-3B illustrate a user interface for a user to graphically select one or more data points.

FIG. 4 illustrates a sample user interface that enables a user to graphically interact with data points.

FIGS. 5A-5C illustrate graphical representations of the results of set operations performed on two data groups.

FIG. 6 is a simplified diagram of a network environment in which specific embodiments of the present invention may be implemented.

### DETAILED DESCRIPTION OF THE INVENTION

The present invention will now be described in detail with reference to a few preferred embodiments thereof as illustrated in the accompanying drawings. In the following description, numerous specific details are set forth in order to provide a thorough understanding of the present invention. It will be apparent, however, to one skilled in the art, that the present invention may be practiced without some or all of these specific details. In other instances, well known process steps and/or structures have not been described in detail in order to not unnecessarily obscure the present invention. In addition, while the invention will be described in conjunction with the particular embodiments, it will be understood that it is not intended to limit the invention to the described embodiments. To the contrary, it is intended to cover alternatives, modifications, and equivalents as may be included within the spirit and scope of the invention as defined by the appended claims.

Businesses and other types of institutions or entities often collect factual-based data for various purposes, such as analyzing market trends, planning for business growth, conducting targeted advertisements, etc. For example, a business may collect various types of information about its customers, such as the customers' age, gender, spending habit, buying power, preferred products, etc. Alternatively, a business may collect factual data about individual business transactions. Often, the amount of factual data collected may be quite large. It is not unusual for a large dataset to contain one million or more multi-dimensional records, where each record represents a customer, a business transaction, an entity, etc. Each record may comprise multiple data values, where each data value represents a particular piece of factual information within the record.

For ease of use, the records in a dataset may be organized as, or otherwise accessible, according to a dimensional data model, such as a table. The following is a sample representation of such a table.

TABLE 1

| | | | Geographical | Annual | Monthly |
|---|---|---|---|---|---|
| Customer ID | Age | Gender | Location | Income | Spending |
| A | 31 | M | CA | $75,000 | $1,200 |
| B | 45 | F | CA | $110,000 | $2,000 |
| C | 27 | F | NY | $65,000 | $1,500 |
| D | 18 | M | WA | $32,000 | $1,300 |
| E | 55 | F | CO | $50,000 | $2,200 |

In the example shown in Table 1, each row of the table represents a single record, and in this case, each record is a customer, identified by a unique customer ID (as shown in the first column). Alternatively in another example, each record/row may be a business transaction or an entity. Each column of the table represents a different dimension of the records, such as a category or a type of data (e.g., age, gender, monthly income, etc.). Inside the cells of the table are the specific data values, each value representing a particular piece of factual information about the corresponding record (e.g., customer or transaction) in a corresponding dimension (e.g., category or characteristic), and a data value may either be a text, a number, or a combination of both. For example, customer A is aged 31, a male, located in California, and so on. The entire table is a collection of facts, and such collection of facts may be referred to as a dimensionally-modeled fact collection.

When working with such large datasets, it may be impractical, even impossible, to display all the multi-dimensional records textually. Instead, it can be more convenient to represent the records graphically in various formats. For example, a scatter plot may be used to graphically represent the records shown in Table 1, with each axis representing a particular dimension (column) and each data point representing a particular record (row). Users may then interact with the data points in the scatter plot graphically (e.g., using a mouse or other method to interact with the graphical display), such as creating and/or defining data groups that comprises subsets of the graphical data points and performing various types of operations and/or analysis on one or more of these data groups. In addition, the results of the operations and analysis may also be displayed in graphical formats, either with the data points or using separate graphical representations.

The inventors have realized that it would be useful to enable users to easily and quickly identify or select graphically displayed data points from a large master dataset to form data groups. In addition, users may desire to move or copy data points from one data group to another data group, add data points to a group, or remove data points from a group. It may also be useful to allow the visualization of each group dynamically as well as visualization of the interactions between the groups.

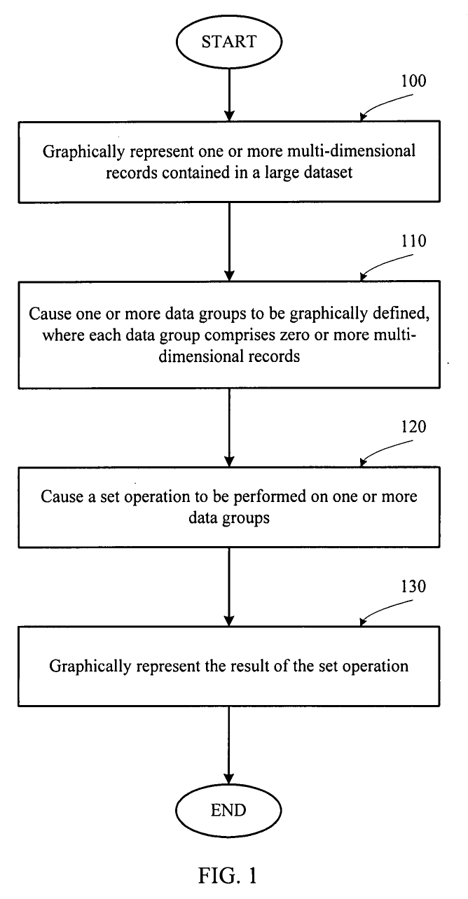

FIG. 1 is a flowchart of a method for a user to graphically interact with a display graphically representing a large dataset. At 100, one or more multi-dimensional records contained in a large dataset are graphically represented. The actual graphical format used to represent the records may vary depending on user preferences. For example, the records may be graphically represented using scatter plots, bar charts, pie charts, geographic charts, or other graphical formats. Axes, colors, sizes, shapes, and other graphical characteristics may be used to graphically represent different dimensions or categories (e.g. different columns of Table 1) of data. The records may be graphically displayed in their raw format or in aggregated format depending on user preferences. Users may choose to display all records (rows of Table 1) of the dataset or a portion of the records. Similarly, users may choose to display all dimensions (columns of Table 1) of the records or a subset of the dimensions.

Using a scatter plot as an example, the axes may represent the dimensions (columns of a table) and the data points may represent the records (rows of a table). Additional graphical characteristics, such as color, size, shape, label, etc., may also be used to represent additional dimensions. The records may be displayed in raw format or in aggregated format. If the records are displayed in raw format, then each data point represents one record. If the records are displayed in aggregated format, then each data point represents multiple records aggregated together.

In order to allow more flexible visualization of the large dataset, in one embodiment, a default master group may be created initially that contains all the records in the dataset, and the records are represented by the data points with each data point representing at least one record. Data points representing these records may then be removed from the master group or copied into new groups. The master group allows the visualization to exclude member records of the other groups as well as show only those member records belonging to the other groups.

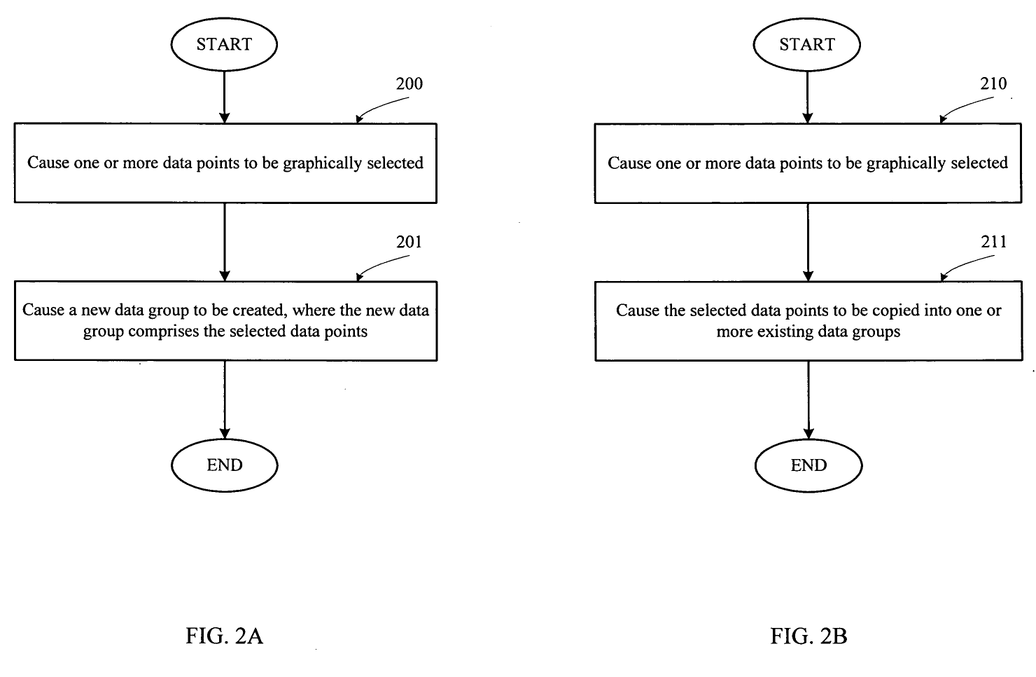

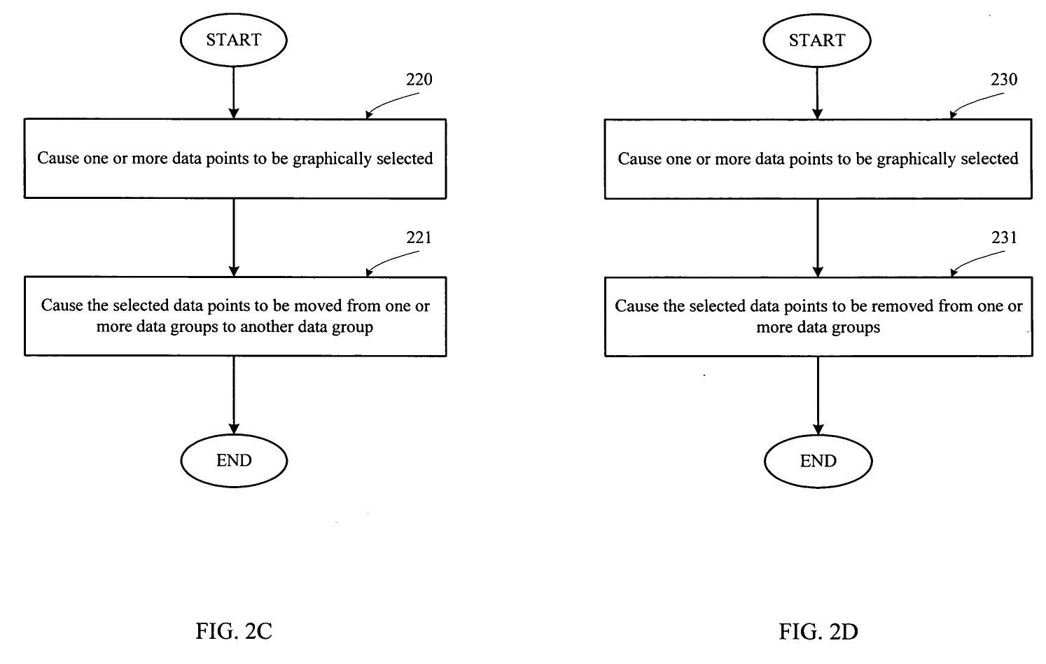

Once the records are displayed graphically, at 10, a user may interact with the display and cause one or more data groups to be created and/or defined, each data group containing a subset of the data points. In other words, each data group may contain anywhere between 0 and n data points, where n is the total number of data points in the master dataset. Furthermore, one data point may belong to multiple data groups. Recall that each data point represents a multi-dimensional record (row of the table), and thus, in effect, each data group comprises 0 or more records. For example, a user may select a subset of the data points and create a new data group. Alternatively, a user may select a subset of the data points and copy or move them into one or more existing data groups. More specifically, a computer operates based on indications of the user's actions with respect to the display to perform these operations. This step is described in more detail below in FIGS. 2A-2D.

At 120, the user may cause various types of analysis to be performed on the data groups, such as performing one or more set operations or statistical operations on one data group or between two or more data groups. The set operations may include the union of two or more groups, the intersection of two or more groups, the exclusion of two or more groups, the exclusion of one group from another group, etc. The statistical operations may include the histogram, mean, median, first quartile, etc. of a data group. Again, the computer actually performs these analysis and/or operations based on the user's input, selection, or control. The user may choose to cause any set operation to be performed on one or more of the data groups. In addition, the user may choose to cause various types of operations to be performed on individual data groups, such as determining the maximum or minimum value of the data points and/or the corresponding records in a particular data group, or calculating the mean value or histogram for the data points and/or the corresponding records in a data group.

At 130, the results of the set operations may be graphically represented in graphical formats, either with the data points or separately. Again, the actual graphical formats used to represent the results may vary depending on user preferences, and colors, sizes, shapes, and other graphical characteristics may be used to graphically distinguish types of operation results.

As will be understood, 100, 110, 120, and 130 may be implemented as a software program. For example, an existing graphical library, such as OpenGL or Java 3D, may be utilized in displaying the data points in various graphical formats and providing the necessary graphical and image functionalities. Data structures such as arrays, sets, or other data structures may be used to represent the records, data points, and/or data groups. The set operations are performed based on their respective mathematical definitions. For example, the result of a union operation between two data groups, group I and group 2, is a group that contains all the data points from either group 1 or group 2. The result of an intersection operation between two data groups, group 1 and group 2, is a group that contains only those data points that originally belong to both group I and group 2.

FIGS. 2A-2D are flowcharts of methods for a user to cause data groups to be defined. These figures describe 110 of FIG. 1 in more detail. There are different ways for a user to cause data groups to be created and/or defined. For example, FIG. 2A is a flowchart of a method for a user to cause a new data group to be created. At 200, the user may cause one or more data points to be graphically selected. Recall that the data points are represented graphically. Thus, in one embodiment, selecting data points of interest may be done by clicking on the individual data points of interest with a mouse while holding down the control key or selecting a group of data points of interest by holding down the left mouse button and dragging the mouse over the group of data points of interest. Since a data point represents a multi-dimensional record, by selecting the data point, the user in effect has caused the corresponding record to be selected. Other methods of selecting one or more graphically displayed graphical objects may also be used, depending on the actual graphical format employed to display the dataset.

Next, at 201, the user may cause a new data group to be created with the selected data points of interest. Again, since each data point represents a multi-dimensional record, the user in effect has caused the corresponding records to be organized into a new group. The user may provide a unique name for the new data group so that the new data group may be identified and referred to easily in the future. Alternatively, if the user chooses not to provide a unique name for the new data group, the software may provide a default unique name for the new data group instead.

From an implementation point of view, assuming an array data structure is used to represent each individual data group, then a new array may be constructed to represent the newly created data group, and the selected data points are the elements of the array.

In another example, FIG. 2B is a flowchart illustrating a method for a user to cause one or more selected data points to be copied into one or more existing data groups. At 210, the user may cause one or more data points to be graphically selected, as described above. At 211, the user may specify one or more existing data groups and cause the previously selected data points to be copied into these specified data groups. The user may highlight each of the data groups into which the selected data points are to be copied by clicking the appropriate data groups using the mouse. After the selected data points are copied into the specified data groups, each specified data group contains a duplicate copy of these selected data points. Since each data point represents a multi-dimensional record, the user in effect has also caused the corresponding records to be copied into the specified data groups.

In another example, FIG. 2C is a flowchart illustrating a method for a user to cause one or more selected data points to be moved from one group to another group. At 220, the user may cause one or more data points to be graphically selected, as described above. At 221, the user may specify the data group into which the selected data points are to be moved by clicking the appropriate data group using the mouse. If the selected data points currently belong to any other data groups, then the selected data points are removed from their current groups and moved into the newly specified group. If the selected data points currently do not belong to any other data groups, then they are simply moved into the newly specified group. Since each data point represents a multi-dimensional record, the user in effect has also caused the corresponding records to be moved into the specified data group.

In another example, FIG. 2D is a flowchart for a user to cause one or more selected data points to be removed from one or more groups. At 230, the user may cause one or more data points to be graphically selected, as described above. At 231, the user may specify one or more data groups from which the selected data points are to be removed. After the selected data points are removed from the specified data groups, each specified data group no longer contains these selected data points. Since each data point represents a multi-dimensional record, the user in effect has also caused the corresponding records to be removed from the specified data groups.

There are additional ways for a user to define data groups. For example, a user may cause an existing data group to be deleted entirely, two or more existing groups to be combined, one group to be divided into multiple groups, etc. The user may cause these operations to be performed by the computer by taking the appropriate actions via a computer-implemented user interface that enables the user to work with the data points and data groups graphically. The actual design and implementation of such a user interface often depends on user preferences. The layout of the user interface may take into consideration the functionalities of the software as well as factors such as easy of use, aesthetics, robustness, etc.

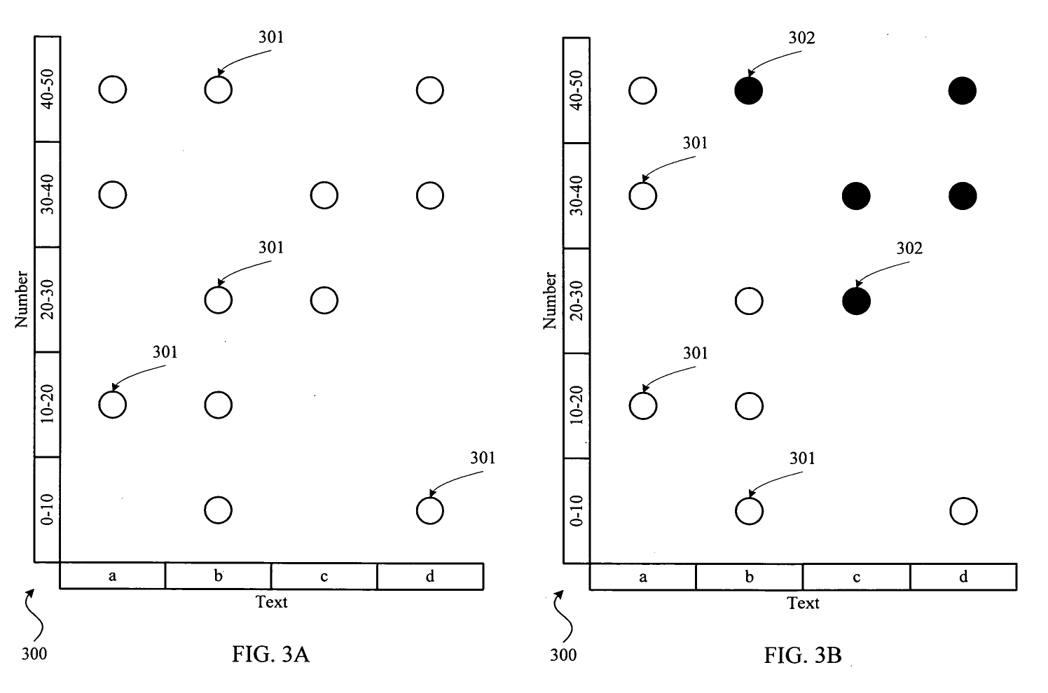

FIGS. 3A-3B illustrate a user interface for a user to graphically select one or more data points. These figures use scatter plots as an example; however, other types of graphical formats may be used. FIG. 3A shows 12 data points 301, each representing a multi-dimensional record, distributed in the scatter plot 300. These data points may be part of a large dataset that represents a dimensionally-modeled fact collection, as shown in Table 1. One axis (e.g., the x-axis) may represent one column (dimension) of data in the table, while another axis (e.g., the y-axis) may represent another column (dimension) of data. When necessary or appropriate, a third axis (e.g., the z-axis) may represent yet another column (dimension) of data in the table. Other types of graphical characteristics, such as color, size, label, shape, etc., may also be used to represent different columns of data. The data points 301 each represents a row (record or customer) of data in the table.

To simply the description, FIG. 3A only displays two dimensions (Text, Number) of the records. Each data point 301 is plotted as the Text value versus the Number value for the corresponding record.

As described above, to select any data point 301, the user may click on the particular data point 301 of interest using a mouse. Alternatively, the user may drag the mouse over a group of data points 301 while holding down the left mouse button.

FIG. 3B shows that among the 12 data points 301 in the scatter plot 300, 5 data points 302 have been selected. In this example, the selected data points 302 are shown in a different color than the unselected data points 301 to graphically indicate to the user which data points have been selected. Other methods may be used to graphically distinguish the selected data points from the unselected data points. For example, the selected data points may be highlighted, shown in a different shape or size, etc.

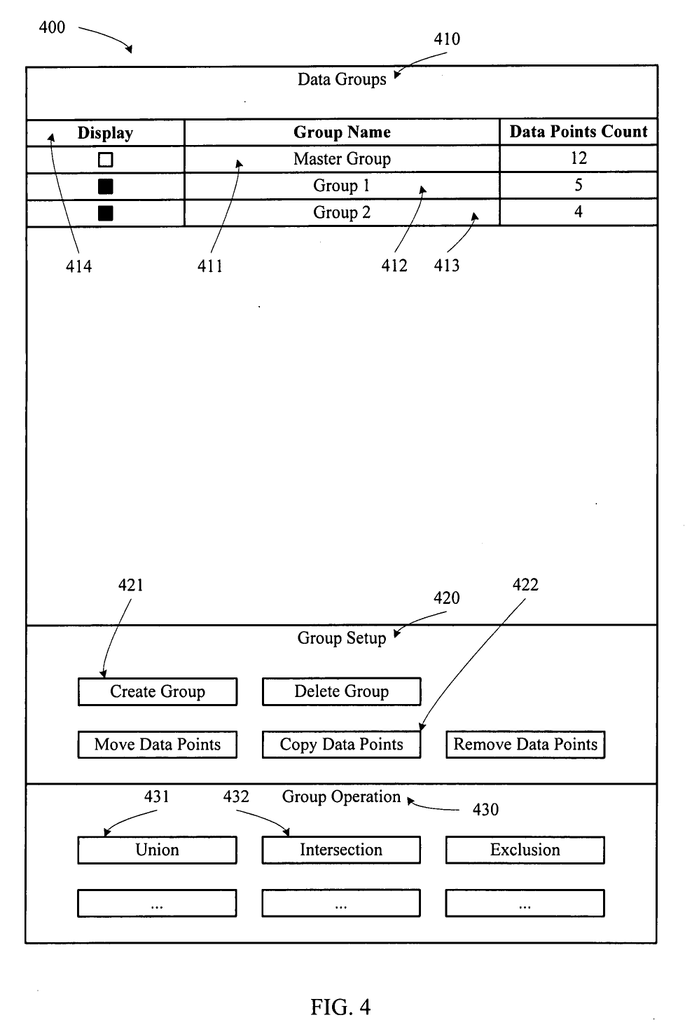

In addition to graphically selecting one or more data points, the user may cause data groups to be defined. The existing data groups may be listed. The user may choose to cause various set operations to be performed on one or more data groups. FIG. 4 illustrates a sample user interface 400 that enables a user to graphically interact with data points in one embodiment. Near the top, the existing data groups 410 are listed. In this example, there is a master group that contains all the original 12 data points in the dataset. In other words, the master group is the original dataset. The user has defined two new data groups. Group 412 (named “Group 1”) contains 5 data points and group 413 (named “Group 2”) contains 4 data points. The user may specify whether a particular data group should be displayed by either check or uncheck the display indicator 414.

Below the group listing are control components 420 that allow the user to define the data groups. The user may indicate what he or she desires to do by clicking on the appropriate control buttons. For example, once the user has selected some data points of interest, the user may click the “Create Group” button 421 to create a new group that contains the selected data points. Alternatively, the user may click the “Copy Data Points” button 422 to copy the selected data points into one or more groups.

Near the bottom is a list of available operations 430 that the user may perform on the data groups. For example, the user may click the “Union” button 431 to perform a union operation on two or more groups, or the “Intersection” button 432 to perform an intersection operation on two or more groups. Additional or different components may be included in different embodiments of the user interface depending on user preferences and to accommodate or handle different types of operations to be performed on the data groups.

In the sample user interface shown in FIG. 4, the controls are implemented as buttons 421, 422, 431, 432. In other implementations, other types of components, such as pull-down menus, selection boxes, etc. may be used. The type of component used to implement the functionalities and the layout of the user interface depends on user preferences.

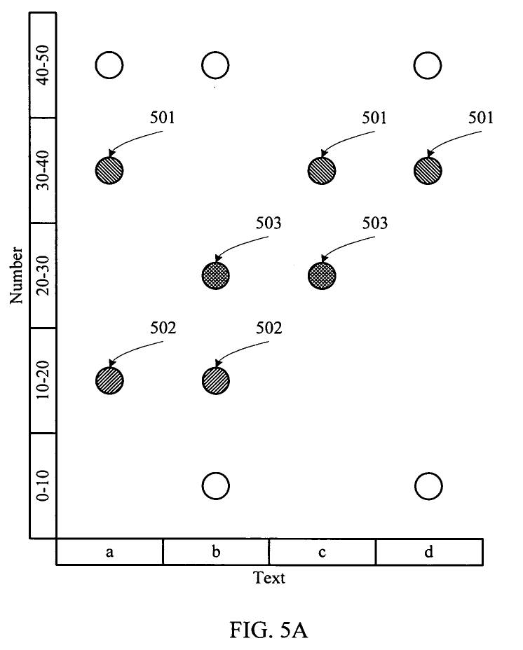

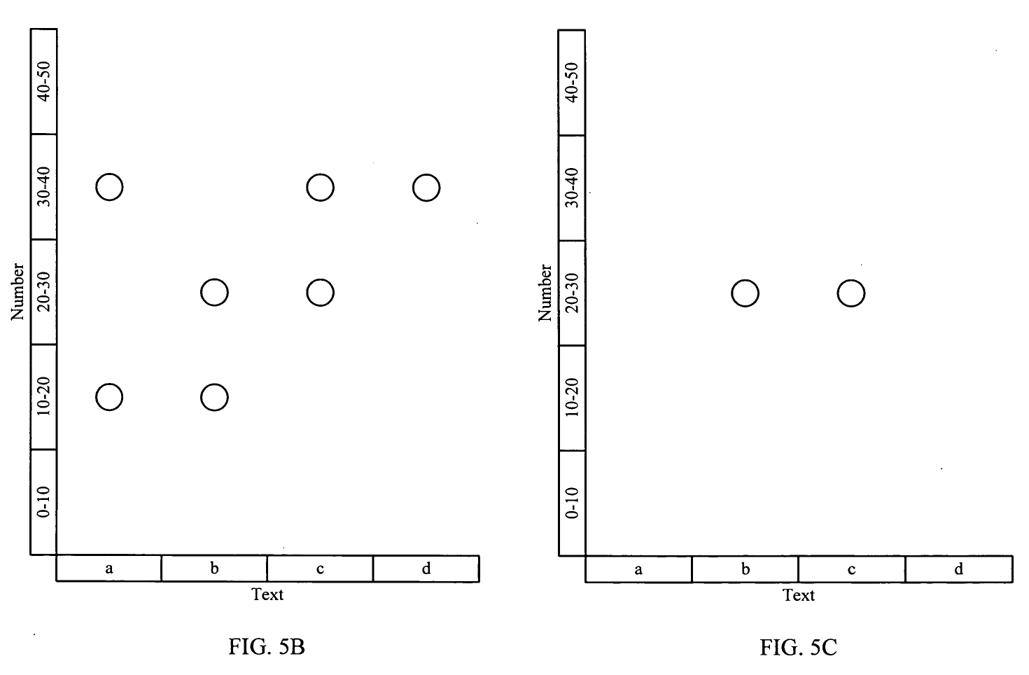

As described above, the results of the operations may also be displayed graphically. FIGS. 5A-5C illustrate graphical representations of the results of set operations performed on two data groups. Assume that the user has caused two data groups, group 1 and group 2, to be defined, with group 1 containing 5 data points and group 2 containing 4 data points. FIG. 5A shows these two data groups. Data points 501 belong to group 1 only. Data points 502 belong to group 2 only. And data points 503 belong to both group 1 and group 2. Graphical characteristics, such as shape, color, size, etc., may be used to distinguish data points belonging to one data group from data points belong to another group.

FIG. 5B shows the result of a union operation between group 1 and group 2, which includes all the data points that belong to either group 1 or group 2. FIG. 5C shows the result of an intersection operation between group 1 and group 2, which only includes those data points that originally belong to both group 1 and group 2.

In FIGS. 5B and 5C, the results of the union and intersection operations are displayed for the same two dimensions (Text and Number) as in FIG. 3A. However, since each data point represents a multi-dimensional record, in effect, by performing the union or intersection operation of the data points belonging to group 1 and group 2, the user in effect has caused the union or intersection of the corresponding records belonging to group 1 and group 2 to be performed. The user may choose to cause the results of the operations to be displayed for different dimensions (columns) other than Text and Number. In fact, any available dimension in the records may be graphically displayed.

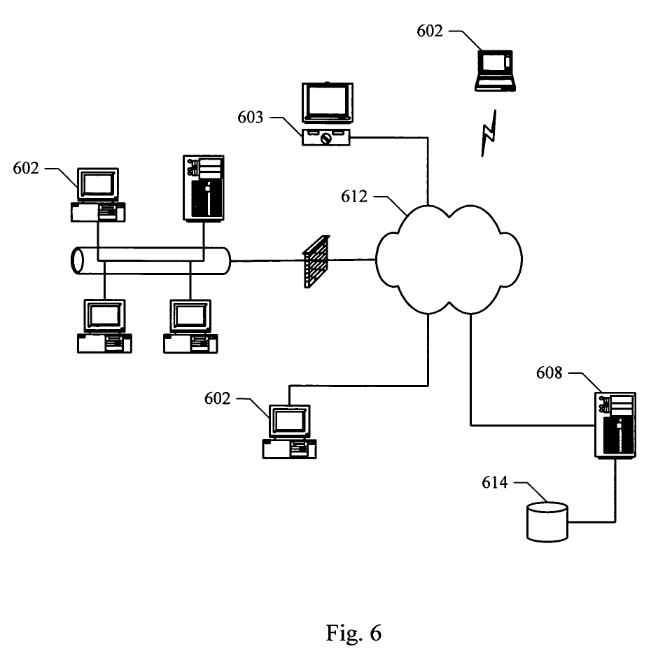

The method described above in FIGS. 1 and 2A-2D may be carried out, for example, in a programmed computing system. FIG. 6 is a simplified diagram of a network environment in which specific embodiments of the present invention may be implemented. The various aspects of the invention may be practiced in a wide variety of network environments (represented by network 612) including, for example, TCP/IP-based networks, telecommunications networks, wireless networks, etc. In addition, the computer program instructions with which embodiments of the invention are implemented may be stored in any type of computer-readable media, and may be executed according to a variety of computing models including, for example, on a stand-alone computing device, or according to a distributed computing model in which various of the functionalities described herein may be effected or employed at different locations.

According to various embodiments, the data values that belong to large datasets may be stored in a database 614. The datasets may be accessed via the network using different methods, such as from computers 602, 603 connected to the network 612.

The software program implementing various embodiments may be executed on the server 608. Alternatively, the software program may be executed on the users' computers 602, 603. The graphical representation of the data points may be displayed on the users' computer screens, and the users may interact with the data points through the user interface provided by the software program.

While this invention has been described in terms of several preferred embodiments, there are alterations, permutations, and various substitute equivalents, which fall within the scope of this invention. It should also be noted that there are many alternative ways of implementing the methods and apparatuses of the present invention. It is therefore intended that the following appended claims be interpreted as including all such alterations, permutations, and various substitute equivalents as fall within the true spirit and scope of the present invention.

What is claimed is:

1. A computer-implemented method of operating a user interface, comprising:
receiving a graphical selection of a subset from a set of data points, each data point representing at least one record of a dimensionally-modeled fact collection;
receiving a graphical manipulation of the selected subset of data points;
defining at least one data group using the selected subset of data points and based on the graphical manipulation, wherein each data group comprises between 0 to n records represented by the selected subset of data points, wherein n is the total number of data points in the set of data points; and
graphically representing the at least one data group.

2. The computer-implemented method, as recited in claim 1, wherein the graphical manipulation of the selected subset of data points includes processing selected from the group consisting of creating a new data group comprising the selected subset of data points, removing the selected subset of data points from a data group, copying the selected subset of data points to a data group, moving the selected subset of data points from a first data group to a second data group, and deleting a group comprising the selected subset of data points.

3. The computer-implemented method, as recited in claim 1, wherein the selected subset of data points comprises between 0 to n data points.

4. The computer-implemented method, as recited in claim 1, further comprising:
graphically representing the set of data points.

5. The computer-implemented method, as recited in claim 1, further comprising:
graphically distinguishing the selected subset of data points using at least one graphical characteristic selected from the group consisting of size, shape, color, label, axis, and text.

6. The computer-implemented method, as recited in claim 1, further comprising:
graphically distinguishing the at least one data group using at least one graphical characteristic selected from the group consisting of size, shape, color, label, axis, and text.

7. A computer-implemented method of operating a user interface, comprising:
performing an operation on at least one data group, wherein each data group comprises between 0 to n records, each record represented by a data point, wherein n is the total number of records in a dimensionally-modeled fact collection, wherein each data point represents at least one record; and
graphically representing a result of the operation.

8. The computer-implemented method, as recited in claim 7, wherein the operation is a set operation or a statistical operation.

9. The computer-implemented method, as recited in claim 8, wherein the operation is one selected from the group consisting of union, intersection, exclusion, maximum, minimum, mean, and histogram.

10. The computer-implemented method, as recited in claim 7, further comprising:
graphically distinguishing the result of the operation using at least one graphical characteristic selected from the group consisting of size, shape, color, label, axis, and text.

11. A computer program product of operating a user interface comprising a computer-readable medium having a plurality of computer program instructions stored therein, which are operable to cause at least one computing device to:
receive a graphical selection of a subset from a set of data points, each data point representing at least one record of a dimensionally-modeled fact collection;
receive a graphical manipulation of the selected subset of data points;
define at least one data group using the selected subset of data points and based on the graphical manipulation, wherein each data group comprises between 0 to n records represented by the selected subset of data points, wherein n is the total number of data points in the set of data points; and
graphically represent the at least one data group.

12. The computer program product, as recited in claim 11, wherein the graphical manipulation of the selected subset of data points includes processing selected from the group consisting of creating a new data group comprising the selected subset of data points, removing the selected subset of data points from a data group, copying the selected subset of data points to a data group, moving the selected subset of data points from a first data group to a second data group, and deleting a group comprising the selected subset of data points.

13. The computer program product, as recited in claim 11, wherein the selected subset of data points comprises between 0 to n data points.

14. The computer program product, as recited in claim 11, wherein the computer program instructions are further operable to cause the at least one computer device to:
graphically represent the set of data points.

15. The computer program product, as recited in claim 11, wherein the computer program instructions are further operable to cause the at least one computer device to:
graphically distinguish the selected subset of data points using at least one graphical characteristic selected from the group consisting of size, shape, color, label, axis, and text.

16. The computer program product, as recited in claim 11, wherein the computer program instructions are further operable to cause the at least one computer device to:
graphically distinguish the at least one data group using at least one graphical characteristic selected from the group consisting of size, shape, color, label, axis, and text.

17. A computer program product of operating a user interface comprising a computer-readable medium having a plurality of computer program instructions stored therein, which are operable to cause at least one computing device to:
perform an operation on at least one data group, wherein each data group comprises between 0 to n records, each record represented by a data point, wherein n is the total number of records in a dimensionally-modeled fact collection, wherein each data point represents at least one record; and
graphically represent a result of the operation.

18. The computer program product, as recited in claim 17, wherein the operation is a set operation or a statistical operation.

19. The computer program product, as recited in claim 18, wherein the operation is one selected from the group consisting of union, intersection, exclusion, maximum, minimum, mean, and histogram.

20. The computer program product, as recited in claim 17, wherein the computer program instructions are further operable to cause the at least one computer device to:
graphically distinguish the result of the operation using at least one graphical characteristic selected from the group consisting of size, shape, color, label, axis, and text.
